(19) United States
(12) Patent Application Publication
(10) Pub. No.: US 2004/0030048 A1
(43) Pub. Date: Feb. 12, 2004

(54) Heterotelechelic polyolefin polymer adducts with epoxides

(75) Inventor: Robert J. Letchford, Cherryville, NC (US)

Correspondence Address: MYERS BIGEL SIBLEY & SAJOVEC, PO BOX 37428, RALEIGH, NC, 27627, US

(73) Assignee: FMC Corporation

(21) Appl. No.: 09/908,442

(22) Filed: Jul. 18, 2001

Related U.S. Application Data
(60) Provisional application No. 60/218,891, filed on Jul. 18, 2000.

(51) Int. Cl. C08F 8/00

(52) U.S. Cl. 525/122

(57) ABSTRACT

Adducts of an epoxy resin and an α,\overline{ω} functional heterotelechelic polyolefin are provided. The adducts generally have the formula R—E—R, wherein R is an α,\overline{ω} functional heterotelechelic polyolefin moiety and E is a polyhydroxy moiety produced by the reaction of an epoxy resin with an α,\overline{ω} functional heterotelechelic polyolefin thereby opening the epoxide rings of the epoxy resin. The heterotelechelic polyolefin can be a α-hydroxy, \overline{ω}-thiol functional polyolefin or a α-hydroxy,\overline{ω}-amine functional polyolefin. The resultant adducts are useful in various applications such as coatings, adhesives, sealants, and the like.

### CROSS-REFERENCE TO RELATED APPLICATIONS

This application is related to copending provisional Application Serial No. 60/218,891 filed Jul. 18, 2000, the entire disclosure of which is hereby incorporated by reference, and claims the benefit of its earlier filing date under 35 USC 119(e).

### FIELD OF THE INVENTION

The present invention relates to adducts of heterotelechelic polymers and epoxides, as well as methods of making and using the same.

### BACKGROUND OF THE INVENTION

Epoxy resins are thermosetting resins based on the reactivity of an epoxide group:

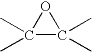

High resistance to chemicals and outstanding adhesion, durability, and toughness have made them valuable as coatings. Because of their high electrical resistance, durability at high and low temperatures, and the ease with which they can be poured or cast without forming bubbles, epoxy resins are especially useful for encapsulating electrical and electronic components. Epoxy resin adhesives can be used on metals, construction materials, and most other synthetic resins.

Despite these and other desirable properties, unmodified epoxies are typically brittle. More flexible grades of epoxy resins can be produced by incorporating other organic moieties into the polymer to modify the epoxy resin structure.

For example, carboxyl functionalities have been incorporated into polyolefins for use in epoxy coatings and adhesives in an attempt to improve flexibility and adhesion, among other properties. As discussed in U.S. Pat. No. 4,088,708, such carboxyl terminated polymers have carbon-carbon backbone linkages derived from polymerization of at least one vinylidene monomer having at least one terminal CH₂═C< group, such as that selected from monoolefins, dienes, and acrylates. Especially useful are carboxyl-terminated copolymers of butadiene and acrylonitrile, referred to in the art as “CTBN” polymers. Typically the carboxyl functional polymers are blended and reacted with polyepoxides to form the desired epoxy resin. See also U.S. Pat. No. 3,823,107.

While such resins can have good properties, carboxyl functionalized polymers are not always useful for every application. Accordingly amine terminated polymers have been developed that are derived from the CTBN polymers described above. For example, amine terminated polymers derived from a CTBN polymer are generally referred to in the art as “ATBN” resins. ATBNs can be prepared as described in U.S. Pat. No. 4,088,708, referenced above, for example by reacting the carboxy functional polymer with a suitable amine, typically a primary amine. The resultant amine terminated polymer includes a carbonyl functionality adjacent the terminal amine group.

There are, however, problems associated with ATBNs as well. The amine terminated polymers typically are not stable in the presence of epoxides, and the viscosity of the mixture can rapidly and dramatically increase. Thus epoxide/ATBN compositions generally exhibit short shelf lives. Although not wishing to be bound by any explanation of this phenomenon, the applicants currently believe that this instability is due to residual primary amines present in the ATBN polymer composition. The primary amines have an additional reactive hydrogen that can react with the epoxy resin and cross link the same. In addition, both CTBN and ATBN polymers can exhibit relatively poor thermal oxidative stability, which limits their use in many applications such as surface coatings.

### SUMMARY OF THE INVENTION

The present invention is directed to unique compounds having various desirable yet contradictory properties. In particular, the present invention provides epoxy adducts of α,\overline{ω} functional heterotelechelic polymers, and in particular heterotelechelic polyolefins having at least one terminal hydroxyl functionality and one other terminal functional group which is different from the hydroxyl functionality, such as an amine or thiol functional group. The adducts of the invention exhibit toughness, chemical resistance and other desired properties imparted thereto by the epoxy component. Yet the adducts also exhibit improved flexibility and impact resistance, due to the incorporation of the polyolefinic backbone into the epoxy adduct. Thus the adducts can be used in a variety of applications, including without limitation coatings, sealants, adhesives, and composites (prepregs).

The epoxy resins can be any suitable epoxide having two or more epoxy functionalities and capable of reacting with the amine-terminated polyolefins. While any diepoxide can be used, one currently preferred diepoxide resin is the diglycidyl ether of Bisphenol A (DGEBA). However, cycloaliphatic epoxies can also be used as well to impart improved thermal oxidative and UV stability.

The heterotelechelic polyolefin is advantageously prepared via anionic polymerization using lithium initiators, and in particular functionalized lithium initiators having a protected hydroxy functionality as known in the art. The resulting living chain end can be functionalized using a thiol or amine functionalized electrophile, in which typically the thiol or amine group is protected. Protecting groups, when present, are removed to liberate the desired functionalities.

The heterotelechelic polyolefins are preferably substantially hydrogenated, so that at least about 70%, or more, of the carbon-carbon double bonds are saturated. The inventors have found that the use of hydrogenated heterotelechelic polyolefins can provide the benefit of improved thermal oxidative stability and UV stability as compared to epoxy adducts having unsaturated polyolefin backbones. Further, the presence of the polyolefin chain can provide other useful properties to the resulting adducts, such as elastomeric properties and improved adhesion of the adducts to polyolefin substrates.

The resulting adducts can be generally represented by the formula

R—E—R

wherein each R is an α,\overline{ω} functional heterotelechelic polyolefin moiety and E is a polyhydroxy moiety produced by the reaction of an epoxy resin with an α,\overline{ω} functional heterotelechelic polyolefin thereby opening the epoxide rings of the epoxy resin. More particularly, the adducts can be represented by formula I:

HO—R₁—Q—E—Q—R₁—OH (I)

wherein each R₁ is a polyolefin, each Q is S or NH, and E is a polyhydroxy moiety produced by the reaction of an epoxy resin with an α,\overline{ω} functional heterotelechelic polyolefin thereby opening the epoxide rings of the epoxy resin.

Particularly preferred adducts include compounds of the formula II:

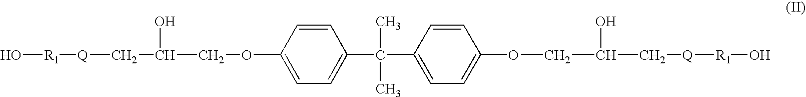

wherein each R₁ is a polyolefin and each Q is S or NH.

The present invention also provides methods for making the adducts of the invention. Generally the adducts can be prepared by reacting an epoxy resin having an epoxide functionality of at least about 2 with a heterotelechelic polyolefin as described herein. The reaction can take place at temperatures ranging from about 0 to about 150° C. for at least about 0.5 hour, and up to 8 hours, although temperature and reaction times outside of these ranges can be employed as well. The reaction can be conducted with an excess amount of the heterotelechelic polyolefin or an excess amount of the epoxy resin.

The present invention also includes methods of chain extending or “advancing” the adducts of the invention to increase solubility of the adducts. In this aspect of the invention the adducts are further reacted with a polyfunctional compound, such as polyols and/or additional diepoxides.

Such advanced adducts can be generally described as having the formula

HO—R₁′—Q—E—Q—R₁′—OH

wherein each R₁′ the reaction product of an α,\overline{ω} functional heterotelechelic polyolefin and at least one polyfunctional compound selected from the group consisting of polyols, polyepoxides, polycarboxylic acids, and mixtures thereof, each Q is S or NH, and E is a polyhydroxy moiety produced by the reaction of the epoxy resin with the α,\overline{ω} functional heterotelechelic polyolefin thereby opening the epoxide rings of the epoxy resin. Particularly preferred advanced adducts include those of the formula:

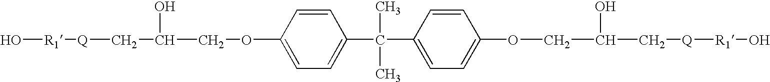

wherein each R₁′ is the reaction product of an α,\overline{ω} functional heterotelechelic polyolefin and at least one polyfunctional compound selected from the group consisting of polyols, polyepoxides, polycarboxylic acids, and mixtures thereof, and each Q is S or NH.

Still further, the invention includes mono-adducts resulting from the reaction of a large stoichiometric excess of epoxy with the heterotelechelic polyolefin. Such a mono-adduct may be generally represented by the formula E″—R″, wherein R″ is an α,\overline{ω} functional heterotelechelic polyolefin moiety and E″ is a hydroxy moiety produced by the reaction of an epoxy resin having at least two epoxide functional groups with an α,\overline{ω} functional heterotelechelic polyolefin under conditions sufficient to open at least one epoxide ring of the epoxy resin and react the same with at least one functional group of the heterotelechelic polymer while maintaining at least one other epoxide group as a terminal epoxide functional group of the adduct. Advantageously E″ has the formula

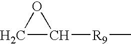

wherein R₉ is an organic moiety derived from said epoxy resin, and R″ has the formula —Q—R₁—OH wherein R₁ is a polyolefin and Q is S or NH. One preferred mono-adduct has the formula

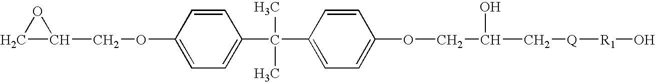

wherein R₁ is a polyolefin and Q is S or NH.

The mono-adducts can also be chain extended or advanced by reaction with at least one polyfunctional compound selected from the group consisting of polyols, polyepoxides and polycarboxylic acids. Such advanced mono-adducts can have the formula

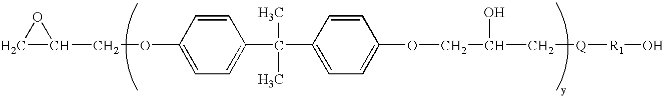

wherein R₁ is a polyolefin, y ranges from 2 to 50 and Q is S or NH.

### DETAILED DESCRIPTION OF THE INVENTION

The present invention now will be described more fully in which preferred embodiments of the invention are described. This invention may, however, be embodied in many different forms and should not be construed as limited to the embodiments set forth herein; rather, these embodiments are provided so that this disclosure will be thorough and complete, and will fully convey the scope of the invention to those skilled in the art.

Preparation of the Epoxy Adducts

The amine-terminated polyolefins are prepared by methods known to those skilled in the art such as those described in U.S. Pat. No. 5,910,547 to Schwindeman et al.; U.S. Pat. No. 6,160,054 to Schwindeman et al.; U.S. Pat. No. 6,197,891 to Schwindeman et al.; and U.S. patent application Ser. No. 09/256,737, filed Feb. 24, 1999, to Schwindeman et al, now U.S. Pat. No. 6,121,474, issued Sep. 19, 2000, which are all incorporated herein by reference in their entirety. See also U.S. patent application Ser. No. 09/665,528, filed Sep. 19, 2000, to Brockmann et al., which is also incorporated herein by reference in its entirety.

For example, a protected hydroxyl functional lithium anionic polymerization initiator, such as described in the above-noted references, may be used to polymerize one or more suitable monomer(s) capable of anionic polymerization, including conjugated alkadienes, alkenylsubstituted aromatic hydrocarbons, and mixtures thereof. An exemplary protected hydroxyl functionalized initiator has the formula:

M—Qₙ—Z—O—(A—R¹R²R³)

wherein:

M is an alkali metal selected from the group consisting of lithium, sodium and potassium;

Z is a branched or straight chain hydrocarbon connecting group which contains 3-25 carbon atoms optionally substituted with aryl or substituted aryl containing lower alkyl, lower alkylthio, or lower dialkylamino groups;

Q is a saturated or unsaturated hydrocarbyl group derived by incorporation of one or more conjugated diene hydrocarbons, one or more alkenylsubstituted aromatic hydrocarbons, or mixtures thereof;

n is a number from 0 to 5; and

(A—R¹R²R³)₂ is a protecting group in which A is an element selected from Group IVa of the Periodic Table of the Elements; and R¹, R², and R³ are independently selected from the group consisting of hydrogen, alkyl, substituted alkyl, aryl, substituted aryl, cycloalkyl, substituted cycloalkyl.

Unless otherwise indicated, as used herein, the term “alkyl” refers to straight chain and branched C1-C25 alkyl. The term “substituted alkyl” refers to C1-C25 alkyl substituted with one or more lower C1-C10 alkyl, lower alkoxy, lower alkylthio, or lower dialkylamino. The term “cycloalkyl” refers to C3-C12 cycloalkyl. The term “substituted cycloalkyl” refers to C3-C12 cycloalkyl substituted with one or more lower C1-C10 alkyl, lower alkoxy, lower alkylthio, or lower dialkylamino. The term “aryl” refers to C5-C25 aryl having one or more aromatic rings, each of 5 or 6 carbon atoms. Multiple aryl rings may be fused, as in naphthyl or unfused, as in biphenyl. The term “substituted aryl” refers to C5-C25 aryl substituted with one or more lower C1-C10 alkyl, lower alkoxy, lower alkylthio, or lower dialkylamino. Exemplary aryl and substituted aryl groups include, for example, phenyl, benzyl, and the like.

The resultant living polymer will include a protected hydroxyl functional group at one terminus and a living chain end at the other terminus. The living chain end may then be functionalized with an amine functional electrophile or a thiol functional electrophile. Exemplary amine functional electrophiles and thiol functional electrophiles include without limitation those described in the aforementioned references, as well as other amine and/or thiol electrophiles as known in the art suitable for providing an amine or thiol functionality to an living polymer chain end. Such functionalizing agents can have the following structure:

X—Y—W—(B—R⁴R⁵R⁶)ₖ

wherein:

X is halogen, preferably chloride, bromide or iodide;

Y is branched or straight chain hydrocarbon connecting groups which contains 1-25 carbon atoms optionally substituted with aryl or substituted aryl containing lower alkyl, lower alkylthio, or lower dialkylamino groups;

W is sulfur or nitrogen;

(B—R⁴R⁵R⁶)ₖ is a protecting group in which B is an element selected from Group IVa of the Periodic Table of the Elements; and R⁴, R⁵ and R⁶ are independently selected from the group consisting of hydrogen, alkyl, substituted alkyl, aryl, substituted aryl, cycloalkyl and substituted cycloalkyl or when W is nitrogen R⁶ is optionally a —(CR⁷R⁸)₁— group linking two B wherein R⁷ and R⁸ are each independently selected from the group consisting of hydrogen, alkyl, substituted alkyl, aryl, substituted aryl, cycloalkyl, and substituted cycloalkyl, and 1 is an integer from 1 to 7; and

k is one when W is sulfur and k is 2 when W is nitrogen.

Thus the skilled artisan will appreciate that when W is nitrogen, R⁶ as used herein includes the group

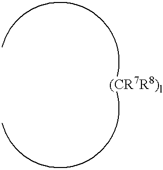

linking two B groups.

The protecting groups, when present, can be removed using techniques known in the art, also as described in the aforementioned references. Residual carbon-carbon double bonds can be hydrogenated until at least 70% or more of the aliphatic unsaturation has been saturated.

Alternatively the heterotelechelic polymers may be prepared using a lithium initiator having a protected amine or thiol group, as known in the art and as described in the foregoing references. Such protected amine or thiol functionalized initiators generally have a structure similar to that described above with regard to the protected hydroxyl functionalized initiators, except that the protected functional group is a nitrogen or sulfur group, instead of oxygen. The resultant amine or thiol functionalized living polymer can then be reacted with a suitable electrophile for providing a terminal hydroxyl group thereto, such as a protected hydroxyl functionalized electrophile, ethylene oxide, and the like. Exemplary protected hydroxyl functional electrophiles include compounds similar to the electrophiles described above, except that the functional group W is oxygen.

Examples of suitable conjugated alkadienes include, but are not limited to, 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl- 1,3-pentadiene, 4,5-diethyl-1,3-octadiene, 2,4-diethyl- 1,3-butadiene, 2,3-di-n-propyl-1,3-butadiene, 2-methyl-3-isopropyl-1,3-butadiene and mixtures thereof.

Examples of polymerizable alkenylsubstituted aromatic hydrocarbons include, but are not limited to, styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene and mixtures of these, as well as alkyl, cycloalkyl, aryl, alkylaryl and arylalkyl derivatives thereof in which the total number of carbon atoms in the combined hydrocarbon constituents is generally not greater than 18. Examples of these latter compounds include 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene and 4,5-dimethyl-1-vinylnaphthalene. U.S. Pat. No. 3,377,404, incorporated herein by reference in its entirety, discloses suitable additional alkenylsubstituted aromatic compounds.

Examples of methods to hydrogenate the polymers of this invention are described in Falk, Journal of Polymer Science: Part A-1, vol. 9, 2617-2623 (1971), Falk, Die Angewandte Chemie, 21, 17-23 (1972), U.S. Pat. Nos. 4,970,254, 5,166,277, 5,393,843, 5,496,898, and 5,717,035. The hydrogenation of the functionalized polymer is conducted in situ, or in a suitable solvent, such as hexane, cyclohexane or heptane. This solution is contacted with hydrogen gas in the presence of a catalyst, such as a nickel catalyst. The hydrogenation is typically performed at temperatures from 25° C. to 150° C., with a archetypal hydrogen pressure of 15 psig to 1000 psig. The progress of this hydrogenation can be monitored by InfraRed (IR) spectroscopy or Nuclear Magnetic Resonance (NMR) spectroscopy. The hydrogenation reaction is conducted until at least 70% of the aliphatic unsaturation has been saturated. The hydrogenated functional polymer is then recovered by conventional procedures, such as removal of the catalyst with aqueous acid wash, followed by solvent removal or precipitation of the polymer.

The polymerization is preferably conducted in a non-polar solvent such as a hydrocarbon, since anionic polymerization in the presence of such non-polar solvents is known to produce polyenes with high 1,4-contents from 1,3-dienes. Inert hydrocarbon solvents useful in practicing this invention include but are not limited to inert liquid alkanes, cycloalkanes and aromatic solvents and mixtures thereof. Exemplary alkanes and cycloalkanes include those containing five to 10 carbon atoms, such as pentane, hexane, cyclohexane, methylcyclohexane, heptane, methylcycloheptane, octane, decane and the like and mixtures thereof. Exemplary aryl solvents include those containing six to ten carbon atoms, such as toluene, ethylbenzene, p-xylene, m-xylene, o-xylene, n-propylbenzene, isopropylbenzene, n-butylbenzene, and the like and mixtures thereof.

Polar solvents (modifiers) can be added to the polymerization reaction to alter the microstructure of the resulting polymer, i.e., increase the proportion of 1,2 (vinyl) microstructure or to promote functionalization or randomization. Examples of polar modifiers include, but are not limited to: diethyl ether, dibutyl ether, tetrahydrofuran (THF), 2-methyltetrahydrofuran, methyl tert-butyl ether (MTBE), diazabicyclo[2.2.2]octane (DABCO), triethylamine, tri-n-butylamine, N,N,N′,N′-tetramethylethylenediamine (TMEDA), and 1,2-dimethoxyethane (glyme). The amount of the polar modifier added depends on the vinyl content desired, the nature of the monomer, the temperature of the polymerization, and the identity of the polar modifier.

The heterotelechelic functional polymer is preferably a hydrogenated polybutadiene, a hydrogenated polyisoprene, or a hydrogenated copolymer of butadiene and isoprene. Preferably, at least about 70%, more preferably at least about 90%, and most preferably up to about 98% of the unsaturated carbon-carbon double bonds in the polymers or copolymers are hydrogenated.

The molecular weight of the amine functional polymer can range from about 1000 to about 200,000, preferably from about 1500 to about 20,000 and more preferably from about 3000 to about 5000. There should be sufficient pendent vinyl groups in the polybutadiene to prevent crystallization of the polymer upon hydrogenation. The functionality of the α,\overline{ω} functional heterotelechelic polyolefin is preferably about 1.0 amine or thiol groups per chain. The amine function may be primary, secondary or tertiary, but primary or secondary amine function is preferred for traditional epoxy cures.

The heterotelechelic polymers can be represented generally by the formula Q—R₁—Q, wherein R₁ is a polyolefin, at least one Q is a hydroxyl group and the other of said Q is an amine or thiol group. In one advantageous embodiment of the invention, the heterotelechelic polymers can be represented generally by the formula

T(H)ₘ—Z—Qₙ—C—Y—W(H)ₖ

wherein:

C represents a hydrogenated or unsaturated block derived by anionic polymerization of one or more conjugated diene hydrocarbons, one or more alkenylsubstituted aromatic hydrocarbons, or mixtures thereof;

Y is a branched or straight chain hydrocarbon connecting group which contains 1-25 carbon atoms optionally substituted with aryl or substituted aryl containing lower alkyl, lower alkylthio, or lower dialkylamino groups;

Z is a branched or straight chain hydrocarbon connecting groups which contains 3-25 carbon atoms optionally substituted with aryl or substituted aryl containing lower alkyl, lower alkylthio, or lower dialkylamino groups;

Q is a saturated or unsaturated hydrocarbyl group derived by incorporation of one or more conjugated diene hydrocarbons, one or more alkenylsubstituted aromatic hydrocarbons, or mixtures thereof;

n is a number from 0 to 5;

T and W are each independently selected from oxygen, sulfur, and nitrogen, with the proviso that at least one of T or W is oxygen and the other of T or W is sulfur or nitrogen; and

k and m are 1 when T or W is oxygen or sulfur, and 2 when T or W is nitrogen.

The epoxy resins can be any suitable epoxide having two or more epoxy functionalities and capable of reacting with the amine-terminated polyolefins. Such epoxides are known in the art and are commercially available.

The thiol/hydroxyl functional heterotelechelic polymers as prepared above are then reacted with epoxy resins to give adducts as shown in FIG. 1:

[image]

In case of a heterotelechelic amine/hydroxyl functional polyolefin, the adduct preparation is shown below in FIG. 2:

[image]

While any diepoxide can be used, the diepoxide resin generally employed for such adducts is the diglycidyl ether of Bisphenol A (DGEBA). Other aromatic epoxies can be used such as the diglycidyl ether of Bisphenol F, or the diglycidyl ether of resorcinol. For improved thermal oxidative and UV stability, it is preferred to use cycloaliphatic epoxies. To maintain fluidity in the above adducts, a low viscosity liquid diepoxide, such as the difunctional novalac of Bisphenol F, can be used. In certain conditions, it may be desirable to use diluents or solvents such as acetone, benzyl alcohol or other polar solvents, to produce the adducts of the invention. For example, to maintain fluidity in the above adducts, preferably n is <2.0 or if n is greater than 2, a solvent such as acetone may be used. However, in addition to the above, a large molar excess (up to 5×) of the α,\overline{ω} functional heterotelechelic polyolefin allows the adducting to be done with ease. Similar schemes can employ tri- and tetra-functional epoxy resins but with adjusted stoichiometries.

For improved thermal oxidative and UV stability, cycloaliphatic epoxy resins can be used in the above adducts instead of DGEBA. Examples of cycloaliphatic epoxy resins include but are not limited to:

From Resolution Performance Products

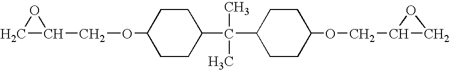

### 2,2-Bis-(4-glycidyloxycyclohexyl)propane (Hydrogenated DGEBA Epoxy Resin)

From Dow/Union Carbide

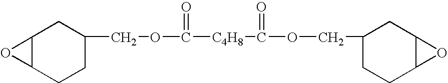

### Bis (3,4-epoxy-6-methylcyclohexyl)adipate

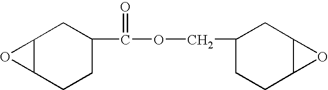

### 3,4-epoxycyclohexylmethyl-3,4-epoxy-cyclohexane-carboxylate

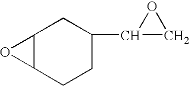

Vinyl Cyclohexane Dioxide

Other cycloaliphatic epoxy resins include without limitation 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, and the like.

Cycloaliphatic epoxy resins like vinyl cyclohexane dioxide, shown above, have epoxy groups of different reactivities, one cycloaliphatic and one non-cycloaliphatic, the amine being more reactive with the non-cycloaliphatic. By use of such an epoxy, coupling can be avoided and it is possible to make adducts where n=1 in FIGS. 1 and 2 above. Other cycloaliphatic epoxy resins with both cycloaliphatic and non-cycloaliphatic epoxy groups are 1,2-epoxy-6-(2,3-epoxypropoxy) hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, o-(2,3-epoxy)cyclopentylphenyl-2,3-epoxypropyl ether, and the like.

If both epoxy groups have equal reactivity with the amine terminated polymer, care must be taken to adjust the stoichiometry and reaction conditions to avoid too much coupling or chain extension, that is bring the value of n as close to 1.0 as possible.

Preferably, the epoxy resins are low molecular weight liquid resins (e.g. having an epoxy equivalent weight of from 76 to 2000); however, for some applications, solid epoxy resins of higher epoxy equivalent weights can also be used.

Catalysts, although not required to manufacture the adducts, can be used to facilitate reactions at or near room temperature. Suitable catalysts include tertiary nitrogen bases, salts, complexes, quaternaries or similar phosphine compounds.

In addition to epoxy systems the adducts produced as described above are useful for other reactive polymers, such as polyurethanes, formed by reacting with isocyanates, or polyesters by reaction with diacids, or polyamides.

Advancement (Chain Extension) of the Adducts

The adducts of the invention can be used in coatings, sealants, adhesives, and composites (prepregs) and can be further combined with additives, stabilizers, pigments, and other ingredients for the desired end use application. However, the adducts of the invention may have limited solubility in standard epoxy formulations for adhesives, sealants, coatings and other applications due to the olefinic nature of the heterotelechelic polyolefin used therein. To increase the solubility and hence compatibility of such adducts, it is preferred to raise the polarity of the adducts by chain extension, often referred to as “advancement” in epoxy chemistry terminology.

This invention covers the advanced resins formed by reacting the adducts of FIG. 1 or FIG. 2 with polyols and/or additional diepoxides, as described below. Because the aliphatic hydroxyl terminus of the polyolefin is less reactive, it is preferable to prepare the mono-adduct of the epoxy resin with the α-hydroxy, \overline{ω}-amine functional polyolefin, as illustrated in FIG. 3 below. When a large stoichiometric excess of epoxy is used and the α-hydroxy, \overline{ω}-amine functional polyolefin is added to the epoxy, the formation of the mono-adduct as shown in FIG. 3 is favored. This mono adduct may then be chain extended or advanced by addition of Bisphenol A which upon heating with addition of a basic catalyst, will react with the epoxy terminus of the adduct and with additional epoxy resin to produce an “advanced” resin.

[image]

The adducts of the invention, e.g., those illustrated in FIGS. 1 and 2 above, can be chain extended or advanced by reacting the adducts with polyols and/or additional diepoxides, by methods known in the art, as described below. These advanced adducts allow control over “critical molecular weight” (Mc), which has implications for toughening/flexibility enhancement, as well as system rheology.

In particular, the advancement of such adducts can be accomplished by reacting the adducts as described above with additional polyhydroxyl group materials and additional polyepoxides such as DGEBA, or other diepoxide compounds as discussed above. The polyhydroxy group materials include, but are not limited to, 1,2-propylene glycol, 1,4-propylene glycol, 1,5-pentanediol, 1,2,6-hexanetriol, glycerol, neopentyl glycol, bis(4-hydroxycyclohexyl)-2,2-propane, Bisphenol A or other polyhydroxy aromatic compounds such as resorcinol, 1,3,5-benzenetriol, 1-2-benzenediol, catechin, ethylene glycol, butylene glycol, 1,6-hexylene glycol, trimethylol propane, pentaerythritol, polyester polyols, polyether polyols, urethane polyols, and acrylic polyols. Other aromatic polyols include 4,4′-dihydroxybenzophenone, bis(4-hydroxyphenyl) 1,1-ethane, bis(4-hydroxyphenyl) 1,1-isobutane, bis(4-hydroxyltertiarybutylphenyl-2,2-propane, bis(2-hydroxynaphthyl)methane, 1,5-dihydroxynaphthylene, or the like. Particularly attractive to high temperature performance are the diepoxides having biphenyl structure, those based on a fluorene diol, or those based on the liquid crystal α-methyl stilbene. Advancement or chain extension reactions of polyepoxides and polyhydroxy materials are described in U.S. Pat. Nos. 3,922,253; 4,001,156; 4,031,050; 4,148,772; 4,468,307; 4,711,917; 4,931,157; and 6,084,036.

Chain extension or advancement can also be carried out by reacting the adducts with polycarboxylic acids in addition to the polyepoxides and/or polyols discussed above. Suitable polycarboxylic acids include, but are not limited to, oxalic acid, succinic acid, glutaric acid, terephthalic acid, 2,6-naphthalene dicarboxylic acid, dimerized linolenic acid, adipic acid, 3,3-dimethylpentanedioic acid, isophthalic acid, phthalic acid, phenylenediethanoic acid, pimelic acid, suberic acid, azelaic acid, sebacic acid, maleic acid, fumaric acid, tetrahydrophthalic acid, hexahydrophthalic acid, and trimellitic acid, and the like (see Epoxy Resins, Chemistry and Technology, Marcel Dekker, 2^{nd} edition(1988), p 757).

Catalysts, although not required for the chain extension of the adducts of the invention, can be used to facilitate reactions at room temperature or higher temperatures, if desired. Suitable catalysts include tertiary nitrogen bases, salts, complexes, quaternaries or similar phosphine compounds.

The following non-limiting examples illustrate the present invention.

### EXAMPLE 1

### Preparation of α-amine, \overline{ω}-hydroxyl Functional Di-Polyolefin Epoxy Adduct (Resin A)

An α-amine, \overline{ω}-hydroxyl functional di-polyolefin epoxy adduct (Resin A) is prepared using the following:

| Ingredients | Parts by Weight (grams) |
|---|---|
| HSA-PEB-50² | 3500 |
| EPON 828¹ | 190 |
| ¹Liquid diglycidyl ether of Bisphenol A having an epoxy equivalent weight of 185 to 192, commercially available from Resolution Performance Products, Houston, TX. | |
| ²α-Amine, ω-hydroxyl functional poly-ethylene-butylene with a number average molecular weight of 3500, prepared as described in the specification from the polymerization of butadiene using a protected secondary amine functional lithium initiator, followed by reaction with ethylene oxide and the hydrogenation. The polymer butylene content is preferably in the range of 30-70%, but the range could be 10-90% of butylene content in the microstructure. The | |
| # polymer has an amine functionality of about 1.0. | |

3500 grams of the HSA-PEB-50, an α-amine, \overline{ω}-hydroxyl functional polyolefin is weighed into a suitable reaction vessel under nitrogen atmosphere and heated to 80° C. Then 190 grams of EPON 828 are slowly added with mechanical stirring, under a nitrogen atmosphere, and the temperature is maintained at 80° C. for 3 hours, until the epoxy resin has completely reacted, to yield the desired di-polyolefin adduct with terminal hydroxyl functionality of about 1.9 functional groups per adduct molecule.

### EXAMPLE 2

### Preparation of α-amine, \overline{ω}-hydroxyl Functional Mono-Polyolefin Epoxy Adduct, Chain Extended with Bisphenol A (Resin B)

An α-amine, \overline{ω}-hydroxyl functional mono-polyolefin epoxy adduct, chain extended with Bisphenol A (Resin B) is prepared using the following:

| Ingredients | Parts by Weight (grams) |
|---|---|
| PART A: | |
| EPON 828¹ | 3800 |
| HSA-PEB-50² | 3500 |
| PART B: | |
| Bisphenol A | 1140 |
| ethyl triphenyl phosphonium iodide | 2.0 |
| ¹Liquid diglycidyl ether of Bisphenol A having an epoxy equivalent weight of 185 to 192, commercially available from Resolution Performance Products, Houston, TX. | |
| ²α-Amine, ω-hydroxyl functional poly-ethylene-butylene with a number average molecular weight of 3500, prepared as described in the specification from the polymerization of butadiene using a protected secondary amine functional lithium initiator, followed by reaction with ethylene oxide and the hydrogenation. The polymer butylene content is preferably in the range of 30-70%, but the range could be 10-90% of butylene content in the microstructure. The | |
| # polymer has an amine functionality of about 1.0. | |

Part A:

3800 grams of EPON 828 is weighed into a suitable reaction vessel under nitrogen atmosphere and heated to 80° C. Then 3500 grams of the HSA-PEB-50, an α-amine, \overline{ω}-hydroxyl functional polyolefin, are added with mechanical stirring, under a nitrogen atmosphere, and the temperature is maintained at 80° C. for 3 hours, until the secondary amine functional groups have completely reacted with the excess epoxy resin. The mixture is then heated to 140° C.

Part B:

In a separate reaction vessel under a nitrogen atmosphere, the Bisphenol A is heated above its melting point to 165° C. While stirring, the advancement catalyst, ethyl triphenyl phosphonium iodide, is added to the molten Bisphenol A and mixed until a uniform mixture is obtained.

After the mixture of PART A has reacted for 3 hours and is heated to 140° C., the Bisphenol A/catalyst mixture from PART B is slowly added to the reaction vessel of PART A. The mixture is allowed to exotherm to 160° C., and reacted at this temperature for an additional two hours. The resultant chain-extended polyolefin epoxy adduct has an epoxide equivalent weight of about 1200.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An adduct of an epoxy resin and an α,\overline{ω} functional heterotelechelic polyolefin having the formula R—E—R, wherein each R is an α,\overline{ω} functional heterotelechelic polyolefin moiety and E is a polyhydroxy moiety produced by the reaction of an epoxy resin with an α,\overline{ω} functional heterotelechelic polyolefin thereby opening the epoxide rings of the epoxy resin.

2. The adduct according to claim 1, wherein the heterotelechelic polyolefin is a α-hydroxy, \overline{ω}-thiol functional polyolefin.

3. The adduct according to claim 1, wherein the heterotelechelic polyolefin is a α-hydroxy, \overline{ω}-amine functional polyolefin.

4. The adduct according to claim 1, wherein the heterotelechelic polyolefin has a molecular weight of from about 1000 to about 200,000.

5. The adduct according to claim 4, wherein the heterotelechelic polyolefin has a molecular weight of from about 1500 to about 5000.

6. The adduct according to claim 1, wherein at least about 70% of the unsaturated carbon-carbon double bonds of the heterotelechelic polyolefin are hydrogenated.

7. The adduct according to claim 1, wherein the heterotelechelic polyolefin is a hydrogenated polybutadiene, a hydrogenated polyisoprene, or a hydrogenated copolymer of butadiene and isoprene.

8. The adduct according to claim 1, wherein the heterotelechelic polyolefin has a functionality of about 1.0 amine or thiol groups per chain.

9. The adduct according to claim 1, wherein the polyhydroxy moiety E is a dihydroxy moiety produced by the reaction of a diepoxide selected from the group consisting of aromatic diepoxide resins and cycloaliphatic diepoxide resins.

10. The adduct according to claim 1, wherein the polyhydroxy moiety E is a dihydroxy moiety produced by the reaction of a diepoxide selected from the group consisting of the diglycidyl ether of bisphenol A; the diglycidyl ether of bisphenol F; the diglycidyl ether of resorcinol; difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy) hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

11. The adduct according to claim 1, wherein the polyhydroxy moiety E is a dihydroxy moiety produced by the reaction of the diglycidyl ether of bisphenol A.

12. The adduct according to claim 1, having the formula I:
HO—R₁—Q—E—Q—R₁—OH (I)
wherein each R₁ is a polyolefin, each Q is S or NH, and E is a polyhydroxy moiety produced by the reaction of an epoxy resin with an α,\overline{ω} functional heterotelechelic polyolefin thereby opening the epoxide rings of the epoxy resin.

13. The adduct according to claim 1, having the formula II: 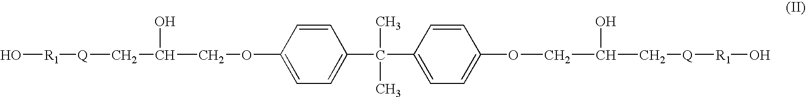
wherein each R₁ is a polyolefin and Q is S or NH.

14. A method of making an adduct of an epoxy resin and α,\overline{ω} functional heterotelechelic polyolefin comprising reacting at least about n moles of an epoxy resin having an epoxide functionality of at least about 2 with at least about 2n moles of an α,\overline{ω}-functional heterotelechelic polyolefin to form the adduct.

15. The method according to claim 14, wherein said reacting step is conducted at a temperature of from about 0 to about 150° C.

16. The method according to claim 14, wherein said reacting step is conducted for at least about 0.5 hour.

17. The method according to claim 16, wherein said reacting step is conducted for at least about 0.5 hour to about 8 hours.

18. The method according to claim 14, wherein said heterotelechelic polyolefin has the formula
T(H)ₘ—Z—Qₙ—C—Y—W(H)ₖ
wherein:
C represents a hydrogenated or unsaturated block derived by anionic polymerization of one or more conjugated diene hydrocarbons, one or more alkenylsubstituted aromatic hydrocarbons, or mixtures thereof;
Z is a branched or straight chain hydrocarbon connecting groups which contains 3-25 carbon atoms optionally substituted with aryl or substituted aryl containing lower alkyl, lower alkylthio, or lower dialkylamino groups;
Y is a branched or straight chain hydrocarbon connecting groups which contains 1-25 carbon atoms optionally substituted with aryl or substituted aryl containing lower alkyl, lower alkylthio, or lower dialkylamino groups;
Q is a saturated or unsaturated hydrocarbyl group derived by incorporation of one or more conjugated diene hydrocarbons, one or more alkenylsubstituted aromatic hydrocarbons, or mixtures thereof;
n is a number from 0 to 5;
T and W are each independently selected from oxygen, sulfur, and nitrogen, with the proviso that at least one of T or W is oxygen and the other of T or W is sulfur or nitrogen; and
k and m are 1 when T or W is oxygen or sulfur, and 2 when T or W is nitrogen.

19. The method according to claim 14, wherein the heterotelechelic polyolefin is a α-hydroxy, \overline{ω}-thiol functional polyolefin.

20. The method according to claim 14, wherein the heterotelechelic polyolefin is α-hydroxy, \overline{ω}-amine functional polyolefin.

21. The method according to claim 14, wherein the heterotelechelic polyolefin has a molecular weight of from about 1000 to about 200,000.

22. The method according to claim 14, wherein at least about 70% of the unsaturated carbon-carbon double bonds of the heterotelechelic polyolefin are hydrogenated.

23. The method according to claim 14, wherein the heterotelechelic polyolefin is a hydrogenated polybutadiene, a hydrogenated polyisoprene, or a hydrogenated copolymer of butadiene and isoprene.

24. The method according to claim 14, wherein the heterotelechelic polyolefin has a functionality of about 1.0 amine or thiol groups per chain.

25. The method according to claim 14, wherein the epoxy resin is a diepoxide selected from the group consisting of aromatic diepoxide resins and cycloaliphatic diepoxide resins.

26. The method according to claim 14, wherein the epoxy resin is a diepoxide selected from the group consisting of the diglycidyl ether of bisphenol A; the diglycidyl ether of bisphenol F; the diglycidyl ether of resorcinol; difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy) hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

27. The method according to claim 14, wherein the epoxy resin is the diglycidyl ether of bisphenol A.

28. The method according to claim 14, wherein said reacting step includes reacting an excess of either said epoxy resin or said heterotelechelic polyolefin.

29. The method according to claim 28, wherein said excess is up to five times the stoichiometric amount of either said epoxy resin or said heterotelechelic polyolefin.

30. The method according to claim 14, wherein the epoxy resin has an epoxy equivalent weight of from 76 to 2000.

31. The method according to claim 14, wherein said reacting step is conducted in a solvent.

32. The method according to claim 31, wherein the solvent is acetone.

33. The method according to claim 14, wherein said reacting step is conducted at or around room temperature.

34. The method according to claim 14, wherein said reacting step is conducted in the presence of a catalyst.

35. The method according to claim 34, wherein the catalyst is selected from the group consisting of tertiary nitrogen bases, salts, complexes, quaternaries or similar phosphine compounds.

36. The reaction product of:
(a) at least one epoxy resin having an epoxide functionality of at least about 2; and
(b) at least one α,\overline{ω}-functional heterotelechelic polyolefin.

37. The reaction product according to claim 36, wherein said heterotelechelic polyolefin has the formula
T(H)ₘ—Z—Qₙ—C—Y—W(H)ₖ
wherein:
C represents a hydrogenated or unsaturated block derived by anionic polymerization of one or more conjugated diene hydrocarbons, one or more alkenylsubstituted aromatic hydrocarbons, or mixtures thereof;
Z is a branched or straight chain hydrocarbon connecting groups which contains 3-25 carbon atoms optionally substituted with aryl or substituted aryl containing lower alkyl, lower alkylthio, or lower dialkylamino groups;
Y is a branched or straight chain hydrocarbon connecting groups which contains 1-25 carbon atoms optionally substituted with aryl or substituted aryl containing lower alkyl, lower alkylthio, or lower dialkylamino groups;
Q is a saturated or unsaturated hydrocarbyl group derived by incorporation of one or more conjugated diene hydrocarbons, one or more alkenylsubstituted aromatic hydrocarbons, or mixtures thereof;
n is a number from 0 to 5;
T and W are each independently selected from oxygen, sulfur, and nitrogen, with the proviso that at least one of T or W is oxygen and the other of T or W is sulfur or nitrogen; and
k and m are 1 when T or W is oxygen or sulfur, and 2 when T or W is nitrogen.

38. The reaction product according to claim 36, wherein the heterotelechelic polyolefin is a α-hydroxy, \overline{ω}-thiol functional polyolefin.

39. The reaction product according to claim 36, wherein the heterotelechelic polyolefin is a α-hydroxy, \overline{ω}-amine functional polyolefin.

40. The reaction product according to claim 36, wherein the epoxy resin is a diepoxide selected from the group consisting of aromatic diepoxide resins and cycloaliphatic diepoxide resins.

41. The reaction product according to claim 36, wherein the epoxy resin is the diglycidyl ether of bisphenol A.

42. A method of advancing an adduct of an epoxy resin and an α,\overline{ω} functional heterotelechelic polyolefin comprising reacting said adduct with at least one polyfunctional compound selected from the group consisting of polyols, polyepoxides, and mixtures thereof.

43. The method according to claim 42, wherein said polyfunctional compound is selected from the group consisting of the diglycidyl ether of bisphenol A; the diglycidyl ether of bisphenol F; the diglycidyl ether of resorcinol; difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5 ,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy) hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, o-(2,3-epoxy)cyclopentylphenyl-2,3-epoxypropyl ether, 1,2-propylene glycol, 1,4 propylene glycol, 1,5-pentanediol, 1,2,6-hexanetriol, glycerol, neopentyl glycol, bis(4-hydroxycyclohexyl)-2,2-propane, Bisphenol A, Bisphenol F, resorcinol, 1,3,5-benzenetriol, 1-2-benzenediol, catechin, ethylene glycol, butylene glycol, 1,6-hexylene glycol, trimethylol propane, pentaerythritol, polyester polyols, polyether polyols, urethane polyols, acrylic polyols, 4,4′-dihydroxybenzophenone, bis(4-hydroxyphenyl)1,1-ethane, bis(4-hydroxyphenyl)1,1-isobutane, bis(4-hydroxyltertiarybutylphenyl-2,2-propane, bis(2-hydroxynaphthyl) methane, and 1,5-dihydroxynaphthylene.

44. The method according to claim 42, wherein said reacting step further comprises reacting at least one polycarboxylic acid with the adduct and the at least one polyfunctional compound.

45. The method according to claim 44, wherein said polycarboxylic acid is selected from the group consisting of oxalic acid, succinic acid, glutaric acid, terephthalic acid, 2,6-naphthalene dicarboxylic acid, dimerized linolenic acid, adipic acid, 3,3-dimethylpentanedioic acid, isophthalic acid, phthalic acid, phenylenediethanoic acid, pimelic acid, suberic acid, azelaic acid, sebacic acid, maleic acid, fumaric acid, tetrahydrophthalic acid, hexahydrophthalic acid, and trimellitic acid.

46. The method according to claim 42, wherein the adduct has the formula R—E—R, wherein each R is a α,\overline{ω} functional heterotelechelic polyolefin moiety and E is a polyhydroxy moiety produced by the reaction of an epoxy resin with an α,\overline{ω} functional heterotelechelic polyolefin thereby opening the epoxide rings of the epoxy resin.

47. The method according to claim 46, wherein the heterotelechelic polyolefin is derived from a polymer of the formula
T(H)ₘ—Z—Qₙ—C—Y—W(H)ₖ
wherein:
C represents a hydrogenated or unsaturated block derived by anionic polymerization of one or more conjugated diene hydrocarbons, one or more alkenylsubstituted aromatic hydrocarbons, or mixtures thereof;
Z is a branched or straight chain hydrocarbon connecting groups which contains 3-25 carbon atoms optionally substituted with aryl or substituted aryl containing lower alkyl, lower alkylthio, or lower dialkylamino groups;
Y is a branched or straight chain hydrocarbon connecting groups which contains 1-25 carbon atoms optionally substituted with aryl or substituted aryl containing lower alkyl, lower alkylthio, or lower dialkylamino groups;
Q is a saturated or unsaturated hydrocarbyl group derived by incorporation of one or more conjugated diene hydrocarbons, one or more alkenylsubstituted aromatic hydrocarbons, or mixtures thereof;
n is a number from 0 to 5;
T and W are each independently selected from oxygen, sulfur, and nitrogen, with the proviso that at least one of T or W is oxygen and the other of T or W is sulfur or nitrogen; and
k and m are 1 when T or W is oxygen or sulfur, and 2 when T or W is nitrogen.

48. The method according to claim 46, wherein the heterotelechelic polyolefin is a α-hydroxy, \overline{ω}-thiol functional polyolefin.

49. The method according to claim 46, wherein the heterotelechelic polyolefin is α-hydroxy, \overline{ω}-amine functional polyolefin.

50. The method according to claim 46, wherein the polyhydroxy moiety E is a dihydroxy moiety produced by the reaction of a diepoxide selected from the group consisting of aromatic diepoxide resins and cycloaliphatic diepoxide resins.

51. The method according to claim 46, wherein the polyhydroxy moiety E is a dihydroxy moiety produced by the reaction of a diepoxide selected from the group consisting of the diglycidyl ether of bisphenol A; the diglycidyl ether of bisphenol F; the diglycidyl ether of resorcinol; difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy) hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

52. The method according to claim 46, wherein the epoxy resin is the diglycidyl ether of bisphenol A.

53. The method according to claim 46, wherein the adduct has the formula I:
HO—R₁—Q—E—Q—R₁—OH (I)
wherein each R₁ is a polyolefin, each Q is S or NH, and E is a polyhydroxy moiety produced by the reaction of an epoxy resin with an α,\overline{ω} functional heterotelechelic polyolefin thereby opening the epoxide rings of the epoxy resin.

54. The method according to claim 46, wherein the adduct has the formula II: 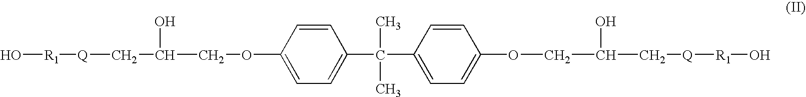
wherein each R₁ is a polyolefin and each Q is S or NH.

55. An advanced adduct of an epoxy resin and an α,\overline{ω} functional heterotelechelic polyolefin having the formula R—E—R, wherein each R is the reaction product of an α,\overline{ω} functional heterotelechelic polyolefin and at least one polyfunctional compound selected from the group consisting of polyols, polyepoxides, polycarboxylic acids, and mixtures thereof and E is a polyhydroxy moiety produced by the reaction of an epoxy resin with the α,\overline{ω} functional heterotelechelic polyolefin thereby opening the epoxide rings of the epoxy resin.

56. The advanced adduct according to claim 55, wherein the heterotelechelic polyolefin is derived from a polymer of the formula
T(H)ₘ—Z—Qₙ—C—Y—W(H)ₖ
wherein:
C represents a hydrogenated or unsaturated block derived by anionic polymerization of one or more conjugated diene hydrocarbons, one or more alkenylsubstituted aromatic hydrocarbons, or mixtures thereof;
Z is a branched or straight chain hydrocarbon connecting groups which contains 3-25 carbon atoms optionally substituted with aryl or substituted aryl containing lower alkyl, lower alkylthio, or lower dialkylamino groups;
Y is a branched or straight chain hydrocarbon connecting groups which contains 1-25 carbon atoms optionally substituted with aryl or substituted aryl containing lower alkyl, lower alkylthio, or lower dialkylamino groups;
Q is a saturated or unsaturated hydrocarbyl group derived by incorporation of one or more conjugated diene hydrocarbons, one or more alkenylsubstituted aromatic hydrocarbons, or mixtures thereof;
n is a number from 0 to 5;
T and W are each independently selected from oxygen, sulfur, and nitrogen, with the proviso that at least one of T or W is oxygen and the other of T or W is sulfur or nitrogen; and
k and m are 1 when T or W is oxygen or sulfur, and 2 when T or W is nitrogen.

57. The advanced adduct according to claim 55, wherein the α,\overline{ω} functional heterotelechelic polyolefin is a α-hydroxy, \overline{ω}-thiol functional polyolefin.

58. The advanced adduct according to claim 55, wherein the α,\overline{ω} functional heterotelechelic polyolefin is a α-hydroxy, \overline{ω}-amine functional polyolefin.

59. The advanced adduct according to claim 55, having the formula I:
HO—R₁′—Q—E—Q—R₁′—OH
wherein each R₁′ the reaction product of an α,\overline{ω} functional heterotelechelic polyolefin and at least one polyfunctional compound selected from the group consisting of polyols, polyepoxides, polycarboxylic acids, and mixtures thereof, each Q is S or NH, and E is a polyhydroxy moiety produced by the reaction of the epoxy resin with the α,\overline{ω} functional heterotelechelic polyolefin thereby opening the epoxide rings of the epoxy resin.

60. The advanced adduct according to claim 59, having the formula: 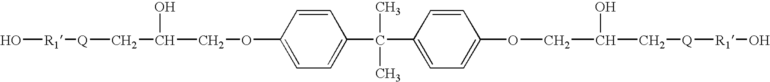
wherein each R₁′ is the reaction product of an α,\overline{ω} functional heterotelechelic polyolefin and at least one polyfunctional compound selected from the group consisting of polyols, polyepoxides, polycarboxylic acids, and mixtures thereof, and each Q is S or NH.

61. The reaction product of:
(a) an adduct of at least one epoxy resin having an epoxide functionality of at least about 2 and at least one α,\overline{ω} functional heterotelechelic polyolefin, and
(b) at least one polyfunctional compound selected from the group consisting of polyols, polyepoxides, polycarboxylic acids, and mixtures thereof.

62. The reaction product of claim 61, wherein the adduct (a) has the formula R—E—R, wherein each R is an α,\overline{ω} functional heterotelechelic polyolefin moiety and E is a polyhydroxy moiety produced by the reaction of an epoxy resin with an α,\overline{ω} functional heterotelechelic polyolefin thereby opening the epoxide rings of the epoxy resin.

63. The reaction product according to claim 62, wherein the adduct (a) has the formula:
HO—R₁—Q—E—Q—R₁—OH (I)
wherein each R₁ is a polyolefin, each Q is S or NH, and E is a polyhydroxy moiety produced by the reaction of an epoxy resin with an α,\overline{ω} functional heterotelechelic polyolefin thereby opening the epoxide rings of the epoxy resin.

64. The reaction product according to claim 63, wherein the adduct (a) has the formula: 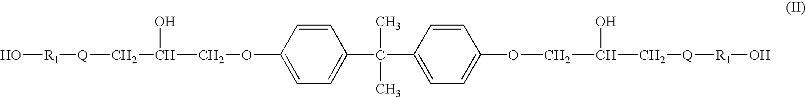
wherein each R₁ is a polyolefin and Q is S or NH.

65. The reaction product according to claim 63, wherein the adduct (a) is the reaction product of said epoxy resin with a heterotelechelic polyolefin of the formula
T(H)ₘ—Z—Qₙ—C—Y—W(H)ₖ
wherein:
C represents a hydrogenated or unsaturated block derived by anionic polymerization of one or more conjugated diene hydrocarbons, one or more alkenylsubstituted aromatic hydrocarbons, or mixtures thereof;
Z is a branched or straight chain hydrocarbon connecting groups which contains 3-25 carbon atoms optionally substituted with aryl or substituted aryl containing lower alkyl, lower alkylthio, or lower dialkylamino groups;
Y is a branched or straight chain hydrocarbon connecting groups which contains 1-25 carbon atoms optionally substituted with aryl or substituted aryl containing lower alkyl, lower alkylthio, or lower dialkylamino groups;
Q is a saturated or unsaturated hydrocarbyl group derived by incorporation of one or more conjugated diene hydrocarbons, one or more alkenylsubstituted aromatic hydrocarbons, or mixtures thereof;
n is a number from 0 to 5′T and W are each independently selected from oxygen, sulfur, and nitrogen, with the proviso that at least one of T or W is oxygen and the other of T or W is sulfur or nitrogen; and
k and m are 1 when T or W is oxygen or sulfur, and 2 when T or W is nitrogen.

66. An adduct of an epoxy resin and an α,\overline{ω} functional heterotelechelic polyolefin having the formula E″—R″, wherein R″ is an α,\overline{ω} functional heterotelechelic polyolefin moiety and E″ is a hydroxy moiety produced by the reaction of an epoxy resin having at least two epoxide functional groups with an α,\overline{ω} functional heterotelechelic polyolefin under conditions sufficient to open at least one epoxide ring of the epoxy resin and react the same with at least one functional group of the heterotelechelic polymer while maintaining at least one other epoxide group as a terminal epoxide functional group of the adduct.

67. The adduct according to claim 66, wherein E″ has the formula 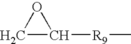
wherein R₉ is an organic moiety derived from said epoxy resin.

68. The adduct according to claim 67, wherein said adduct has the formula 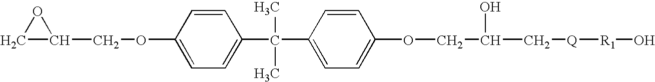
wherein R₁ is a polyolefin and Q is S or NH.

69. An advanced adduct of an epoxy resin and an α,\overline{ω} functional heterotelechelic polyolefin, comprising an adduct of claim 66 which is further reacted with at least one polyfunctional compound selected from the group consisting of polyols, polyepoxides, polycarboxylic acids, and mixtures thereof.

70. The advanced adduct according to claim 69 having the formula 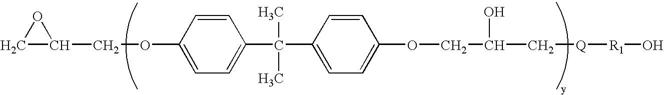
wherein R₁ is a polyolefin, y ranges from 2 to 50 and Q is S or NH.

71. A coating, adhesive or sealant, comprising the compound of any of claims 1, 36, 55, 61, 66, and 69.
